(19) United States
(12) Patent Application Publication
(10) Pub. No.: US 2021/0339188 A1
(43) Pub. Date: Nov. 4, 2021

(54) A PROCESS FOR CAPTURING CARBON DIOXIDE

(71) Applicant: SHELL OIL COMPANY, HOUSTON, TX (US)

(72) Inventors: Anjana Kalpesh BHALODI, Bangalore (IN); Sander VAN PAASEN, Beijing (CN); Mélina INFANTINO, Montreal (CA); Aikaterini GRIGORIADOU, The Hague (NL); Stefan Henricus Angelina Maria LEENDERS, Amsterdam (NL)

(21) Appl. No.: 17/271,885

(22) PCT Filed: Aug. 29, 2019
(86) PCT No.: PCT/EP2019/073108

§ 371 Date: Feb. 26, 2021

(30) Foreign Application Priority Data
Aug. 31, 2018 (EP) 18386028.7

(51) Int. Cl. B01D 53/12; B01J 20/26; B01J 20/28; B01J 20/34

(52) U.S. Cl. CPC B01D 53/12; B01J 20/26; B01J 20/28016; B01J 20/3483; B01J 20/3425; B01D 2259/40098; B01D 2253/25; B01D 2257/504; B01D 2258/0283; B01D 2259/402; B01D 2253/202

(57) ABSTRACT

The present invention provides a process for capturing CO₂ from a gas stream, the process at least comprising the steps of: (a) providing a CO₂-containing gas stream; (b) contacting the gas stream as provided in step (a) in an adsorption zone with solid adsorbent particles thereby obtaining CO₂-enriched solid adsorbent particles (c) passing CO₂-enriched solid adsorbent particles as obtained in step (b) from the bottom of the adsorption zone to the bottom of a first desorption zone; (d) removing a part of the CO₂ from the CO₂-enriched solid adsorbent particles in the first desorption zone, thereby obtaining partly CO₂-depleted solid adsorbent particles and a first CO₂-enriched gas stream; (e) passing the partly CO₂-depleted solid adsorbent particles as obtained in step (d) via a riser to a second desorption zone; (f) removing a further part of the CO₂ from the partly CO₂-depleted solid adsorbent particles in the second desorption zone thereby obtaining regenerated solid adsorbent particles and a second CO₂-enriched gas stream; and (g) recycling regenerated solid adsorbent particles as obtained in step (f) to the adsorption zone of step (b); wherein the second desorption zone is located above the adsorption zone.

The present invention relates to a process for capturing carbon dioxide (CO₂) from a gas stream using solid adsorbent particles, in particular from gas streams with relatively low CO₂ content (less than 25 mol. % CO₂), such as flue gas.

Processes for removal of carbon dioxide from gas streams using solid adsorbent particles are known in the art.

An example of a process for capturing CO₂ from a gas stream whilst using solid adsorbent particles has been described in WO2016074980, the disclosure of which is hereby incorporated by reference. According to WO2016074980 carbon dioxide can be removed from a gas stream by contacting the gas stream with a regenerable solid adsorbent in a counter-current multistage fluidized bed. Although WO2016074980 already discloses a simple, effective and energy-efficient process for capturing CO₂, there is a continuous desire to improve the process.

A problem of the process as described in WO2016074980 is that for circulation of the solid absorbent particles a relatively large number of risers is used. This may result in an increased risk in stagnation of the solids circulation and distribution, and in increased solids transportation gas requirements.

Another problem of the method as described in WO2016074980 is that it requires (see step (e) of claim 1 of WO2016074980) the presence of at least one internal heating means (such as a heating coil) in each of the beds of the fluidized solid absorbent particles of the desorption and adsorption zone.

It is an object of the present invention to solve, minimize or at least reduce one or more of the above problems.

It is a further object of the present invention to provide an alternative process for capturing CO₂ from a gas stream using solid adsorbent particles, in particular requiring fewer internal heating means (such as heating coils).

One or more of the above or other objects may be achieved according to the present invention by providing a process for capturing carbon dioxide (CO₂) from a gas stream, the process at least comprising the steps of:

(a) providing a CO₂-containing gas stream;
(b) contacting the gas stream as provided in step (a) in an adsorption zone with solid adsorbent particles thereby obtaining CO₂-enriched solid adsorbent particles, wherein the adsorption zone has at least two beds of fluidized solid adsorbent particles and wherein the solid adsorbent particles are flowing downwards from bed to bed and wherein the gas stream is flowing upwards;
(c) passing CO₂-enriched solid adsorbent particles as obtained in step (b) from the bottom of the adsorption zone to the bottom of a first desorption zone (or ‘pre-regenerator’);
(d) removing a part of the CO₂ from the CO₂-enriched solid adsorbent particles in the first desorption zone, thereby obtaining partly CO₂-depleted solid adsorbent particles and a first CO₂-enriched gas stream;
(e) passing the partly CO₂-depleted solid adsorbent particles as obtained in step (d) via a riser to a second desorption zone (or ‘regenerator’);
(f) removing a further part of the CO₂ from the partly CO₂-depleted solid adsorbent particles in the second desorption zone thereby obtaining regenerated solid adsorbent particles and a second CO₂-enriched gas stream, wherein the second desorption zone has at least two beds of fluidized solid adsorbent particles and wherein the solid adsorbent particles are flowing downwards from bed to bed and a stripping gas is flowing upwards; and
(g) recycling regenerated solid adsorbent particles as obtained in step (f) to the adsorption zone of step (b);

wherein the second desorption zone (‘regenerator’) is located above the adsorption zone.

It has surprisingly been found according to the present invention that by the vertical stacking of the second desorption zone (‘regenerator’) relative to the adsorption zone, the circulation and distribution of solid adsorbent particles over the (one or more adsorption vessels of the) adsorption zone is improved by the increased use of gravity flow. As less mechanical rotary devices and/or risers are required for the transport of the solid adsorbent particles in the process, this results in less fine production and less loss of the solid adsorbent particles and reduces the solids transportation gas requirements.

A further advantage of the process according to the present invention is that fewer internal heating and cooling means (such as heating or cooling coils) are required, in particular in the (combined first and second) desorption zone(s) and the adsorption zone. The heating coils requirement may be reduced in the desorption zone(s) by increasing the uptake of water (by the solid adsorbent particles) in the desorption zone(s). The cooling coils requirement may be reduced in the adsorption zone by increasing the release of water in the adsorption zone. Water release and uptake may be manipulated by controlling the relative humidity in the desorption zone(s) and the adsorption zone.

As the person skilled in the art is familiar with adsorption zones, desorption zones, solid adsorbent particles (and fluidization thereof), risers and the like, these terms will not be discussed here in full detail. For more information on fluidization of solids, reference is made to “Fluidization Engineering”, Butterworth-Heinemann Ltd, October 1991 (ISBN 0-409-90233-0) and “Fluidization, Solids Handling and Processing, Industrial Applications”, Wen-Ching Yang, 1998 (ISBN 978-0-8155-1427-5).

In step (a), a CO₂-containing gas stream is provided. The CO₂-containing gas stream is not limited in any way (in terms of composition, temperature, pressure, etc.), as long as it contains CO₂. The CO₂-containing gas stream may have various origins; as mere examples, the CO₂-containing gas stream may be natural gas, associated gas, synthesis gas, gas originating from coal gasification, coke oven gas, refinery gas or flue gas.

Typically, the CO₂-containing gas stream comprises from 0.1 to 70 mol. % CO₂, preferably from 2.0 to 45 mol. % CO₂, more preferably from 3.0 to 30 mol. % CO₂. In case the process is used for a stream with a relatively low CO₂ content (e.g. flue gas), then the CO₂-containing gas stream comprises preferably at most 25 mol. % CO₂.

Preferably, the CO₂-containing gas stream as provided in step (a) has an oxygen (O₂) concentration of at most 15 mol. % (and preferably lower). In case the CO₂-containing gas stream is flue gas, then it typically contains O₂ in the range of from 0.25 to 15 mol. % O₂.

Typically, the CO₂-containing gas stream as provided in step (a) has a temperature in the range of from 0 to 90° C., preferably from 15 to 80° C., more preferably below 35° C. Further, the CO₂-containing gas stream as provided in step (a) typically has a pressure in the range of from 0.5 to 5.0 bara, preferably above 1.0 bara and preferably below 3.0 bara. If appropriate, the stream may have been pre-processed to obtain the desired composition and conditions.

Generally, the CO₂-containing gas stream as provided in step (a) has a water content of from 5 to 20 mol. %. Preferably, the water dew point temperature of the CO₂-containing gas stream as provided in step (a) is at least 20° C. below the operating temperature in the bottom of the adsorption zone.

In step (b), the gas stream as provided in step (a) is contacted (counter-currently) in an adsorption zone with solid adsorbent particles thereby obtaining CO₂-enriched solid adsorbent particles (and a CO₂-depleted gas stream), wherein the adsorption zone has at least two beds of fluidized solid adsorbent particles and wherein the solid adsorbent particles are flowing downwards from bed to bed and wherein the gas stream is flowing upwards.

The adsorption zone has at least two beds of fluidized solid adsorbent particles. The beds are arranged above each other. The solid adsorbent particles are flowing downwards from bed to bed, and the gas stream is flowing upwards. The adsorption zone preferably comprises in the range of from 2 up to 30, more preferably from 3 up to 15, beds of fluidized solid adsorbent particles. The solid adsorbent particles enter the top of the adsorption zone as regenerated solid adsorbent particles. If needed, fresh solid adsorbent particles may be added from time to time.

Preferably, the beds of fluidized solid adsorbent particles in the adsorption zone are present above sieve plates and/or nozzle plates. Preferably, these sieve plates and/or nozzle plates comprise overflow weirs. Preferably, these sieve plates and/or nozzle plates comprise downcomers. Most preferably the sieve plates and/or nozzle plates comprise downcomers and overflow weirs.

Once the solid adsorbent particles reach the bottom of the adsorption zone, they are CO₂-enriched.

The CO₂-containing gas stream entering the adsorption zone (near the bottom thereof) typically has a lower temperature than the CO₂-depleted gas stream leaving the adsorption zone (at the top thereof). Preferably, the CO₂-containing gas stream entering the adsorption zone has a temperature in the range from 0 to 90° C., preferably below 60° C., more preferably below 55° C. Preferably, the temperature at the top of the adsorption zone is from 50° C. to 140° C., preferably below 120° C., more preferably below 80° C. Typically, the temperature gradient from the bottom to the top of the adsorption zone is in the range from 3 to 30° C., preferably above 5° C. and preferably below 25° C. The temperature gradient allows to increase the evaporation in the top of the adsorption zone, whilst maintaining a relatively negligible water take up capacity in the bottom of the adsorption zone at lower temperatures. Water take-up and condensation may be further managed by having the dew point of the incoming gas stream to be treated at least 20° C. below the operating temperature of the bottom of the adsorption zone. Also, by keeping the temperature in the adsorption zone higher in the top than at the bottom, water tends to evaporate from the solid adsorbent particles resulting in a cooling effect (thereby reducing the need for cooling means such as cooling coils in the adsorption zone).

The temperature of the gas stream at which water in the gas stream will start to condense out of the gaseous phase is the dew point of the gas stream. The dew point is pressure dependent.

The pressure of the gas stream in the adsorption zone is higher at the bottom of the adsorption zone than at the top of the adsorption zone.

Preferably, step (b) is carried out at a pressure in the range of from 0.8 to 8 bara, more preferably 0.8 to 4 bara, even more preferably 0.8 to 1.5 bara.

When the gas stream leaves at the top of the adsorption zone as a CO₂-depleted gas stream, its pressure may be equal to or close to atmospheric pressure. When the gas stream enters the adsorption zone the pressure may be above atmospheric pressure, e.g. 1.05 bara. The total pressure drop over the adsorption zone, e.g. an adsorption column, can be relatively small, it may for example be 50 mbar.

The dew point of the gas stream entering the adsorption zone in step (a) can be adjusted by adjusting the humidity of the gas stream.

According to an especially preferred embodiment of the present invention, the adsorption zone comprises two or more adsorption vessels, each adsorption vessel containing at least two beds of fluidized solid adsorbent particles and each adsorption vessel defining a separate flow path for a part of the solid adsorbent particles and a part of the gas stream. Preferably, the two or more adsorption vessels are juxtaposed (i.e. placed next to each other). In this embodiment, the gas stream as provided in step (a) is split before the adsorption zone, then flows through the two or more adsorption vessels and is combined before it enters the first desorption zone or is combined in the first desorption zone. This embodiment wherein the adsorption comprises two or more adsorption vessels is in particular suitable for larger capacities above a gas flow rate of 35 m³/s.

The solid adsorbent particles as used according to the present invention are not particularly limited. Typically, these particles are made entirely from an adsorbent material or comprise a support material coated with an adsorbing coating. Also, the solid adsorbent particles may have various shapes. As the person skilled in the art is familiar with this kind of solid adsorbent particles this is not discussed here in full detail. Adsorbent materials have been described in for example: “Adsorbent material for carbon dioxide capture from large anthropogenic point sources”, Choi et al., 2009 (https://doi.org/10.1002/cssc.200900036); “CO₂ capture by solid adsorbents and their applications: current status and new trends”, Wang et al., Energy & Environmental Science, Issue 1, 2011; and “Flue gas treatment via CO₂ adsorption”, Sayari et al., Chemical Engineering Journal, Volume 171, Issue 3, p760-774, 15 Jul. 2011.

Typically, the solid adsorbent particles have an average particle diameter (d50) in the range of from 100 to 800 micrometer, preferably from 300 to 700 micrometer, and an average porosity in the range of from 10 to 70%, preferably from 20 to 50%. Further, it is preferred that the solid adsorbent particles have a nitrogen content of from 5 to 15 wt. %, based on the dry weight of the solid adsorbent particles.

Typically, the solid adsorbent particles comprise an organic amine material such as one or more primary, secondary and/or tertiary amine compounds, preferably primary and secondary amine compounds. Benzylamines have been found particularly useful.

In case a support material is used, then the person skilled in the art will readily understand that a wide variety of support materials can be used including but not limited to carbon, silica, alumina, titania, zirconia, magnesium oxide, crosslinked polymers (e.g. polystyrene crosslinked with divinylbenzene), etc.

Preferably, the solid adsorbent particles indeed comprise a porous support functionalized with an organic amine material such as one or more of the amine compounds mentioned above.

Examples of particularly suitable adsorbent materials are benzylamines functionalized onto a polystyrene support or silica impregnated with polyethyleneimines or grafted with aminoalkylalkoxysilanes.

In step (b) CO₂-enriched solid adsorbent particles and a CO₂-depleted gas stream are obtained. Preferably more than 70%, more preferably more than 80%, even more preferably more than 90%, still more preferably more than 95% of CO₂ is removed, calculated on the total amount of CO₂ in the gas stream that is contacted with solid adsorbent particles in step (b).

In step (c), CO₂-enriched solid adsorbent particles as obtained in step (b) are passed from the bottom of the adsorption zone to the bottom of a first desorption zone (‘pre-regenerator’), preferably via gravity flow. If desired, the CO₂-enriched solid adsorbent particles may be heated before entering the first desorption zone, e.g. using an external heat exchanger.

Although the first desorption zone is not particularly limited, and may have different forms, it typically has the form of a vessel or a pipe, the diameter of which is broader than the diameter of the riser. Different to the second desorption zone, the first desorption zone has no beds that are vertically arranged above each other; also, the solid adsorbent particles travel in the same direction as the gas, i.e. co-currently.

In the first desorption zone, the solid adsorbent particles move from the bottom to the top by using a pressurized stripping gas. The stripping gas typically comprises at least 40 mol. % steam, preferably at least 50 mol. %, more preferably at least 99 mol. %.

Preferably, the first desorption zone (‘pre-regenerator’) is located below the adsorption zone. This, to allow for gravitational flow between the adsorption zone and the first desorption zone.

Further, it is preferred that the solid adsorbent particles near the top of the first desorption zone are heated. This can be achieved for example by heat exchange. Also, it is preferred that the first desorption zone (‘pre-regenerator’) contains internal heating means (such as heating coils), preferably near the top thereof. This results in less heating being required in the second desorption zone. Also, as the first desorption zone is preferably placed lower than the second desorption zone thereby keeping the load closer to the ground (compared to having the same heating applied at the high replaced second desorption zone).

In step (d), a part of the CO₂ is removed from the CO₂-enriched solid adsorbent particles in the first desorption zone, thereby obtaining partly CO₂-depleted solid adsorbent particles and a first CO₂-enriched gas stream.

The first CO₂-enriched gas stream and the partly CO₂-depleted solid adsorbent particles leave the desorption zone at the top thereof and will typically travel jointly through the riser in step (e) as the riser is preferably connected to the top of the first desorption zone.

Typically, in step (d), at least 20% of the CO₂ is removed from the CO₂-enriched solid adsorbent particles in the first desorption zone, calculated based on the CO₂-enriched solid adsorbent particles entering the first desorption zone.

Preferably step (d) is carried out at a temperature in the range of from 100 to 140° C., preferably 110 to 130° C. Further, it is preferred that step (d) is carried out at a pressure in the range of from 0.8 to 8 bara, more preferably 0.8 to 4 bara, even more preferably 0.8 to 1.5 bara.

In step (e), the partly CO₂-depleted solid adsorbent particles (and typically also the first CO₂-enriched gas stream) as obtained in step (d) are passed via a riser to a second desorption zone (‘regenerator’), typically to near the top of the second desorption zone.

Although the riser is not particularly limited, it usually is a pipe. In case the first desorption zone has the form of a pipe, then the riser typically has a smaller diameter than the first desorption zone.

Typically, a riser gas is used to move the partly CO₂-depleted solid adsorbent particles upwards through the riser. Preferably the riser gas comprises at least 40 mol. % CO₂, preferably at least 60 mol. % CO₂. Usually, the riser gas comprises at least in part recycle gas streams as generated elsewhere in the process, preferred embodiments being described further below.

In step (f), a further part of the CO₂ from the partly CO₂-depleted solid adsorbent particles is removed in the second desorption zone thereby obtaining regenerated solid adsorbent particles and a second CO₂-enriched gas stream, wherein the second desorption zone has at least two beds of fluidized solid adsorbent particles and wherein the solid adsorbent particles are flowing downwards from bed to bed and a stripping gas is flowing upwards. Hence, similar to the adsorption zone, the gas and the solids are flowing counter-currently in the second desorption zone.

Typically, in step (f), at least 70% of the CO₂ is removed from the partly CO₂-depleted solid adsorbent particles in the second desorption zone, calculated based on the partly CO₂-depleted solid adsorbent particles entering the second desorption zone. The second CO₂-enriched gas stream typically contains less CO₂ than the first CO₂-enriched gas stream as steam is usually used as stripping gas the second desorption zone.

As mentioned above, the second desorption zone has at least two beds of fluidized solid adsorbent particles. The beds are arranged above each other. The solid adsorbent particles are flowing downwards from bed to bed and a stripping gas is flowing upwards.

The second desorption zone preferably comprises in the range of from 3 up to 10, more preferably from 4 up to 8 beds of fluidized solid adsorbent particles.

Preferably, the beds of fluidized solid adsorbent particles in the second desorption zone are present above sieve plates and/or nozzle plates. Preferably these sieve plates and/or nozzle plates comprise overflow weirs. Preferably these sieve plates and/or nozzle plates comprise downcomers. Most preferably the sieve plates and/or nozzle plates comprise downcomers and overflow weirs.

Typically, in the second desorption zone, a stripping gas is used. Usually, the stripping gas comprises at least 50 mol. % steam, preferably at least 90 mol. %, more preferably least 99 mol. % steam.

Preferably step (f) is carried out at a temperature in the range of from 100 to 140° C., preferably 110 to 130° C. Further, it is preferred that step (f) is carried out at a pressure in the range of from 0.8 to 8 bara, more preferably 0.8 to 4 bara, even more preferably 0.8 to 1.5 bara.

The second desorption zone (‘regenerator’) may or may not comprise internal heating means such as heating coils. Preferably less than half of the beds are provided with heating coils. However, it is preferred that the second desorption zone is operated without such internal heating means.

Preferably, the partly CO₂-depleted solid adsorbent particles as passed via a riser in step (e) are separated in a gas/solids separator before entering the second desorption zone, thereby obtaining a solids-enriched and a gas-enriched stream, wherein the solids-enriched stream is passed to the second desorption zone. A suitable gas/solids separator is a cyclone. Preferably, the gas/solids separator is located above the second desorption zone.

According to an especially preferred embodiment of the present invention, at least part of the gas-enriched stream obtained in the gas/solids separator is used as a riser gas in the riser of step (e).

As an alternative or in addition to separating the partly CO₂-depleted solid adsorbent particles as passed via the riser in step (e) in a gas/solids separator as mentioned above, preferably at least a part of the partly CO₂-depleted solid adsorbent particles as passed via the riser in step (e) and fed into the second desorption zone are separated in the top of the second desorption zone, thereby obtaining a solids-enriched and a gas-enriched stream, wherein the solids-enriched stream is passed on in the second desorption zone and wherein at least a part of the gas-enriched stream is used as a riser gas in the riser of step (e).

According to a preferred embodiment according to the present invention, the second desorption zone (‘regenerator’) does not contain internal heating means (such as heating coils). As also mentioned above, this may be achieved according to the present invention by applying the heating at the first desorption zone. This results in less or no heating means such as heating coils being required in the second desorption zone (although heat may of course still be added by recycling a warm stream from elsewhere in the process). As the first desorption zone is preferably placed lower than the second desorption zone thereby keeping the load of heating coils closer to the ground (compared to having the same heating applied at the higher replaced second desorption zone) this results in constructional advantages.

In step (g), regenerated solid adsorbent particles as obtained in step (f) are recycled to the adsorption zone of step (b), typically to near the top thereof. As the second desorption zone (‘regenerator’) is located above the adsorption zone, the regenerated solid adsorbent particles are recycled via gravity flow in step (g).

Preferably, the regenerated solid adsorbent particles as obtained in step (f) are cooled before entering the adsorption zone. This cooling can for example be achieved by using one or more of a heat exchanger, a wet spray, a dry inert gas (such as nitrogen) or dry atmospheric air.

According to an especially preferred embodiment according to the present invention, water is added to the regenerated solid adsorbent particles that are being recycled in step (g) to the adsorption zone of step (b), before the regenerated solid adsorbent particles enter the adsorption zone.

This addition of water can be achieved in various ways, e.g. by using a water spray. The addition of water results in an increase of the water content of the solid adsorbent particles in the adsorption zone, which provides for more evaporation of water in the adsorption zone and associated cooling. This cooling reduces the requirement of indirect cooling means such as heat exchangers or the like. Preferably, the regenerated solid adsorbent particles being entered into the adsorption zone have a water content in the range of from 4 to 16 wt. %.

In a further aspect, the present invention provides an apparatus suitable for performing the

process for capturing carbon dioxide (CO₂) from a gas stream according to the present invention, the apparatus at least comprising:
an adsorption zone for contacting a CO₂-containing gas stream with solid adsorbent particles thereby obtaining CO₂-enriched solid adsorbent particles, wherein the adsorption zone has at least two beds of fluidized solid adsorbent particles and wherein during use the solid adsorbent particles can flow downwards from bed to bed and wherein the CO₂-containing gas stream can flow upwards;
a first desorption zone (‘pre-regenerator’) for receiving the CO₂-enriched solid adsorbent particles as obtained in the adsorption zone and removing a part of the CO₂ from the CO₂-enriched solid adsorbent particles, thereby obtaining partly CO₂-depleted solid adsorbent particles and a first CO₂-enriched gas stream;
a riser for passing the partly CO₂-depleted solid adsorbent particles as obtained in the first desorption zone to a second desorption zone (‘regenerator’);
the second desorption zone for removing a further part of the CO₂ from the partly CO₂-depleted solid adsorbent particles in the second desorption zone thereby obtaining regenerated solid adsorbent particles and a second CO₂-enriched gas stream, wherein the second desorption zone has at least two beds of fluidized solid adsorbent particles and wherein the solid adsorbent particles can flow downwards from bed to bed and a stripping gas can flow upwards; and
a recycle line for recycling regenerated solid adsorbent particles as obtained in the second desorption zone to the adsorption zone;

wherein the second desorption zone (‘regenerator’) is located above the adsorption zone.

Hereinafter the present invention will be further illustrated by the following non-limiting drawings. Herein shows:

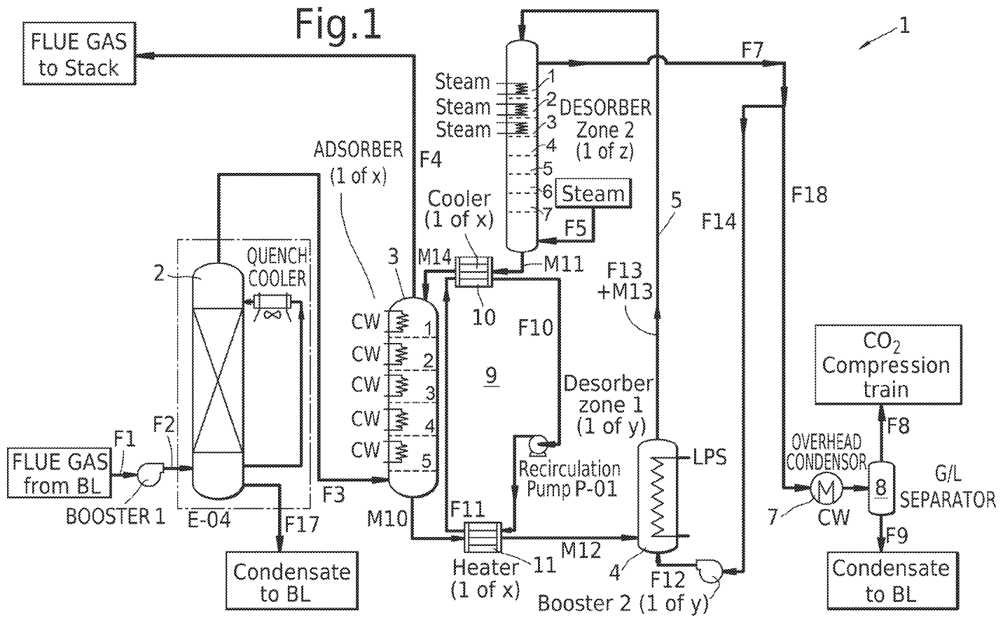

FIG. 1 schematically a flow scheme of the process for capturing CO₂ from a gas stream according to the present invention.

For the purpose of this description, same reference numbers refer to same or similar components.

The flow scheme of FIG. 1 generally referred to with reference number 1, shows a quench cooler 2, an adsorption zone 3, a first desorption zone 4, a riser 5, a second desorption zone 6, an overhead condenser 7 and a g/l-separator 8. Furthermore, FIG. 1 shows a heat exchange cycle 9, containing heat exchangers 10 (a cooler) and 11 (a heater).

During use, a CO₂-containing flue gas stream is provided as stream F3. As shown in the embodiment of FIG. 1, the stream F3 was pressurized (as stream F1) in a booster and pre-treated (as stream F2) in a water quench in quench cooler 2 (for water knock-out and temperature adjustment). Before entering the adsorption zone 3 near the bottom thereof, the stream F3 may be split in several streams which are treated in parallel in two or more separate adsorption vessels, wherein each adsorption vessel defines a flow path for a part of the solid adsorbent particles and a part of the gas stream.

Although not clearly reflected in the (schematic) FIG. 1, the second desorption zone 6 is located above the adsorption zone 3, thereby allowing for gravity flow for the solid adsorbent particles between the second adsorption zone 6 and the adsorption zone 3.

The gas streams F3 is contacted with solid adsorbent particles in the adsorption zone 3 thereby obtaining CO₂-enriched solid adsorbent particles and a CO₂-depleted stream. The CO₂-depleted stream leaves the adsorption zone 3 as stream F4 and is for example sent to a flue gas stack (in case the feed stream F1 would be a flue gas).

In the embodiment of FIG. 1, the adsorption zone 3 has five beds of fluidized solid adsorbent particles. The solid adsorbent particles are flowing downwards from bed to bed whilst the gas stream is flowing upwards, hence counter-currently. As shown in the embodiment of FIG. 1, each of the beds in the adsorption zone 3 is provided with cooling means (in the form of cooling coils). However, and as preferred according to the present invention, at least the two lowest beds in the adsorption zone 3 can do without such cooling coils to save on CAPEX costs.

The CO₂-enriched solid adsorbent particles as obtained in the adsorption zone 3 are passed via gravity flow (not fully reflected in FIG. 1) as stream M10 from the bottom of the adsorption zone 3 to the bottom of the first desorption zone (the ‘pre-regenerator’) 4, in which the solid adsorbent particles are partly regenerated. In the embodiment of FIG. 1, stream M10 is heated in heat exchanger 11 and enters the first desorption zone 4 as stream M12.

In the first desorption zone 4 (in the embodiment of FIG. 1 located below the adsorption zone 3 to allow gravity flow for the streams M10 and M12), a part of the CO₂ is removed from the CO₂-enriched solid adsorbent particles, thereby obtaining partly CO₂-depleted solid adsorbent particles (stream M13) and a first CO₂-enriched gas stream (F13). As shown, the first desorption 4 zone contains a heating coil that uses a heating fluid (e.g. low-pressure steam) to heat up the solid adsorbent particles.

To help the solid adsorbent particles stream fed as M12 pass through the first desorption zone 4 (and subsequently through the riser 5), stream F12 (as discussed below) is used as a riser gas.

The partly CO₂-depleted solid adsorbent particles M13 and the first CO₂-enriched gas stream F13 are passed together via the riser 5 to the second desorption zone (the ‘regenerator’) 6.

As shown in the embodiment of FIG. 1, the combined stream M13+F13 is fed into the second desorption zone 6 (at the top thereof) and separated in the top thereof, thereby obtaining a solids-enriched stream and a gas enriched stream. The solids-enriched stream flows downwards (by gravity flow) from bed to bed in the second desorption zone 6. The gas-enriched stream leaves the second desorption zone 6 near the top thereof as stream F7. In the embodiment of FIG. 1, stream F7 is the combination of (steam) stream F5 after having passed upwards through the second desorption zone 6 whilst picking up some CO₂ and the gas stream F13 as passed through the riser 5 and fed into the top of the second desorption zone 6.

As shown in the embodiment of FIG. 1, the gas-enriched stream F7 is split in two streams F14 and F18. Stream F14 is pressurized in a booster and fed to the bottom of the first desorption zone 4 to help the solid adsorbent particles pass therethrough and through the riser 5 in the upwards direction.

Stream F18 is sent to the overhead condenser 7 and separated in g/l-separator 8. CO₂-rich overhead stream F8 may be sent to a compression train for subsequent compression and storage (not shown); condensate stream F9 may be sent to e.g. a wastewater treatment plant.

As shown in FIG. 1, the second desorption zone 6 comprises in this embodiment seven beds, whilst heating is provided (via steam-heated coils) in only the upper part of the second desorption zone 6 and in only three of the seven beds (i.e. less than half). Further, steam is added near the bottom of the second desorption zone 6 via stream F5. In a preferred embodiment of the present invention, the second desorption zone 6 does not contain any heating coils (or other indirect heating means) at all.

In the second desorption zone 6 a further part of the CO₂ from the partly CO₂-depleted solid adsorbent particles is removed thereby obtaining regenerated solid adsorbent particles and a second CO₂-enriched gas stream. The second CO₂-enriched gas stream (also containing steam) moves upwards through the second desorption zone 6 and leaves the second desorption zone 6 as stream F7, whilst the regenerated solid adsorbent particles are recycled as stream M11 (via gravity flow) to the adsorption zone 3. As shown in the embodiment of FIG. 1 the regenerated solid adsorbent particles in stream M11 are cooled in heat exchanger 10 and enter the top of the adsorption zone 3 as stream M14.

### EXAMPLE

The flow scheme of FIG. 1 was used for illustrating the capture of CO₂ from a gas stream. The compositions and conditions of the fluid (i.e. gas and liquid) streams in the various flow lines are provided in Table 1 below and for the solid streams they are indicated in Table 2.

As solid adsorbent particles, spherically-shaped Lewatit VP OC 1065 particles (a weak base anionic exchange resin, commercially available from Lanxess (Cologne, Germany)) were used, having a particle size of from 315 to 1250 micrometer, an average total surface area of 50 m²/g and a pore volume of 0.3 ml/g.

TABLE 1

| | Fluid stream | | | | | | | | |
|---|---|---|---|---|---|---|---|---|---|
| | F1 | F2 | F3 | F4 | F5 | F6 | F7 | F8 | F9 |
| Phase | V | V | V | V | V | V | V | V | L |
| T [° C.] | 92 | 100 | 30 | 57 | 120 | 119 | 118 | 30 | 30 |
| p [bara] | 1.00 | 1.07 | 1.07 | 1.00 | 1.70 | 1.00 | 1.00 | 1.00 | 1.00 |
| CO₂ [kg/s] | 41.45 | 41.45 | 41.45 | 4.15 | — | 15.61 | 43.59 | 37.30 | — |
| H₂O [kg/s] | 35.53 | 35.53 | 16.22 | 23.52 | 23.42 | 8.84 | 18.85 | 0.67 | 15.44 |
| N₂ [kg/s] | 466.01 | 466.01 | 466.01 | 466.01 | — | — | — | — | — |
| O₂ [kg/s] | 86.13 | 86.13 | 86.13 | 86.13 | — | — | — | — | — |
| Ar [kg/s] | 7.18 | 7.18 | 7.18 | 7.18 | — | — | — | — | — |
| CO₂ [mol. %] | 4.2 | 4.2 | 4.4 | 0.5 | — | 41.9 | 48.6 | 95.8 | — |
| H₂O [mol. %] | 8.8 | 8.8 | 4.2 | 6.2 | 100 | 58.1 | 51.4 | 4.2 | 100 |
| N₂ [mol. %] | 74.2 | 74.2 | 77.9 | 79.6 | — | — | — | — | — |
| O₂ [mol. %] | 12.0 | 12.0 | 12.6 | 12.9 | — | — | — | — | — |
| Ar [mol. %] | 0.8 | 0.8 | 0.8 | 0.9 | — | — | — | — | — |

| | Fluid stream | | | | | | |
|---|---|---|---|---|---|---|---|
| | F10 | F11 | F12 | F13 | F14 | F17 | F18 |
| Phase | L | L | V | V | V | L | V |
| T [° C.] | 104 | 75 | 137 | 118 | 118 | 30 | 118 |
| p [bara] | 3 | 8 | 1.20 | 1.00 | 1.00 | 1.00 | 1.00 |
| CO₂ [kg/s] | — | — | 6.29 | 27.98 | 6.29 | — | 37.30 |
| H₂O [kg/s] | 172.04 | 172.04 | 2.73 | 10.00 | 2.73 | 19.31 | 16.12 |
| N₂ [kg/s] | — | — | — | — | — | — | — |
| O₂ [kg/s] | — | — | — | — | — | — | — |
| Ar [kg/s] | — | — | — | — | — | — | — |
| CO₂ [mol. %] | — | — | 48.6 | 53.4 | 48.6 | — | 48.6 |
| H₂O [mol. %] | 100 | 100 | 51.4 | 46.6 | 51.4 | 100 | 51.4 |
| N₂ [mol. %] | — | — | — | — | — | — | — |
| O₂ [mol. %] | — | — | — | — | — | — | — |
| Ar [mol. %] | — | — | — | — | — | — | — |

TABLE 2

| | Solid stream | | | | |
|---|---|---|---|---|---|
| | M10 | M11 | M12 | M13 | M14 |
| T [° C.] | 50 | 120 | 88 | 118 | 100 |

As can be seen from Table 1, the process according to the present invention allows for an effective way of capturing carbon dioxide from a CO₂-containing stream: by passing through the adsorption zone 3, the CO₂-containing flue gas stream F3 (4.4 mol. % CO₂) was for 90% reduced in CO₂ content after leaving the adsorption zone as stream F4 (0.5 mol. % CO₂).

Further, the CO₂-containing gas stream F8 leaving the gas/liquid-separator 8 has a high purity (and contains apart from CO₂ mainly moisture). This stream F8 is suitable to be compressed in standard compressors and suitable to be used in various industrial processes to produce various products, for CO₂ storage, in greenhouses to accelerate plant growth, etc.

Also, the process according to the present invention is suitable for large gas flows (to be fed as stream F3 to the adsorption zone), containing low or high CO₂ concentrations.

The person skilled in the art will readily understand that many modifications may be made without departing from the scope of the invention. Further, the person skilled in the art will readily understand that, while the present invention in some instances may have been illustrated making reference to a specific combination of features and measures, many of those features and measures are functionally independent from other features and measures given in the respective embodiment(s) such that they can be equally or similarly applied independently in other embodiments.

1. A process for capturing carbon dioxide (CO₂) from a gas stream, the process at least comprising the steps of:
(a) providing a CO₂-containing gas stream;
(b) contacting the gas stream as provided in step (a) in an adsorption zone with solid adsorbent particles thereby obtaining CO₂-enriched solid adsorbent particles, wherein the adsorption zone has at least two beds of fluidized solid adsorbent particles and wherein the solid adsorbent particles are flowing downwards from bed to bed and wherein the gas stream is flowing upwards;
(c) passing CO₂-enriched solid adsorbent particles as obtained in step (b) from the bottom of the adsorption zone to the bottom of a first desorption zone;
(d) removing a part of the CO₂ from the CO₂-enriched solid adsorbent particles in the first desorption zone, thereby obtaining partly CO₂-depleted solid adsorbent particles and a first CO₂-enriched gas stream;
(e) passing the partly CO₂-depleted solid adsorbent particles as obtained in step (d) via a riser to a second desorption zone;
(f) removing a further part of the CO₂ from the partly CO₂-depleted solid adsorbent particles in the second desorption zone thereby obtaining regenerated solid adsorbent particles and a second CO₂-enriched gas stream, wherein the second desorption zone has at least two beds of fluidized solid adsorbent particles and wherein the solid adsorbent particles are flowing downwards from bed to bed and a stripping gas is flowing upwards; and
(g) recycling regenerated solid adsorbent particles as obtained in step (f) to the adsorption zone of step (b);
wherein the second desorption zone is located above the adsorption zone.

2. The process according to claim 1, wherein the adsorption zone comprises two or more adsorption vessels, each adsorption vessel containing at least two beds of fluidized solid adsorbent particles and each adsorption vessel defining a separate flow path for a part of the solid adsorbent particles and a part of the gas stream.

3. The process according to claim 1, wherein the first desorption zone is located below the adsorption zone.

4. The process according to claim 1, wherein the solid adsorbent particles near the top of the first desorption zone are heated.

5. The process according to claim 1, wherein the first desorption zone contains internal heating means,
and wherein preferably the second desorption zone does not contain internal heating means.

6. The process according to claim 1, wherein the partly CO₂-depleted solid adsorbent particles as passed via a riser in step (e) are separated in a gas/solids separator before entering the second desorption zone, thereby obtaining a solids-enriched and a gas-enriched stream, wherein the solids-enriched stream is passed to the second desorption zone,
and wherein preferably at least part of the gas-enriched stream obtained in the gas/solids separator is used as a riser gas in the riser of step (e).

7. The process according to claim 1, wherein at least a part of the partly CO₂-depleted solid adsorbent particles as passed via the riser in step (e) and fed into the second desorption zone are separated in the top of the second desorption zone, thereby obtaining a solids-enriched and a gas-enriched stream, wherein the solids-enriched stream is passed on in the second desorption zone and wherein at least a part of the gas-enriched stream is used as a riser gas in the riser of step (e).

8. The process according to claim 1, wherein the regenerated solid adsorbent particles as obtained in step (f) are cooled before entering the adsorption zone.

9. The process according to claim 1, wherein water is added to the regenerated solid adsorbent particles that are being recycled in step (g) to the adsorption zone of step (b), before the regenerated solid adsorbent particles enter the adsorption zone.

10. An apparatus suitable for performing the
process for capturing carbon dioxide (CO₂) from a gas stream according to claim 1, the apparatus at least comprising:
an adsorption zone for contacting a CO₂-containing gas stream with solid adsorbent particles thereby obtaining CO₂-enriched solid adsorbent particles, wherein the adsorption zone has at least two beds of fluidized solid adsorbent particles and wherein during use the solid adsorbent particles can flow downwards from bed to bed and wherein the CO₂-containing gas stream can flow upwards;
a first desorption zone for receiving the CO₂-enriched solid adsorbent particles as obtained in the adsorption zone and removing a part of the CO₂ from the CO₂-enriched solid adsorbent particles, thereby obtaining partly CO₂-depleted solid adsorbent particles and a first CO₂-enriched gas stream;
a riser for passing the partly CO₂-depleted solid adsorbent particles as obtained in the first desorption zone to a second desorption zone;
the second desorption zone for removing a further part of the CO₂ from the partly CO₂-depleted solid adsorbent particles in the second desorption zone thereby obtaining regenerated solid adsorbent particles and a second CO₂-enriched gas stream, wherein the second desorption zone has at least two beds of fluidized solid adsorbent particles and wherein the solid adsorbent particles can flow downwards from bed to bed and a stripping gas can flow upwards; and
a recycle line for recycling regenerated solid adsorbent particles as obtained in the second desorption zone to the adsorption zone;
wherein the second desorption zone is located above the adsorption zone.
